(19) United States
(12) Patent Application Publication
(10) Pub. No.: US 2012/0134526 A1
(43) Pub. Date: May 31, 2012

(54) POP-UP TWEETER

(75) Inventor: Se Min OH, Seongnam (KR)

(73) Assignees: KIA MOTORS CORPORATION, Seoul (KR); HYUNDAI MOTOR COMPANY, Seoul (KR)

(21) Appl. No.: 13/172,689

(22) Filed: Jun. 29, 2011

(30) Foreign Application Priority Data
Nov. 30, 2010 (KR) 10-2010-0120984

(51) Int. Cl. H04R 1/02

(52) U.S. Cl. 381/386

(57) ABSTRACT

Provided is a tweeter (e.g., a pop-up tweeter) which includes a speaker 120 provided at the top of a cylindrical casing 100. A driving unit 110 is inserted into the casing 100 and configured to move the speaker 120 upward and downward. Additionally, a cover unit 121 is provided at the top end of the speaker 120 and configured to have an illumination unit 122 formed therein to emit light from the tweeter. The pop-up tweeter is configured to have the opening and closing structure within a vehicle, thereby improving user convenience. Furthermore, an external design of the pop-up tweeter can be improved through the emission of illumination.

### CROSS-REFERENCE TO RELATED APPLICATION

Priority to Korean patent application number 10-2010-0120984, filed on Nov. 30, 2010, which is incorporated by reference in its entirety, is claimed

### BACKGROUND OF THE INVENTION

1. Field of the Invention

The present invention relates to a pop-up tweeter and, more particularly, to a pop-up tweeter which enables an opening and closing structure according to the use of the tweeter installed in a vehicle and also enables the emission of illumination in the tweeter.

2. Background of the Invention

Typically, an audio system is installed in a vehicle, and a user can listen to the radio and music in the vehicle through its associated components. The audio system for a vehicle chiefly includes an antenna, a media source (i.e., a radio tuner, a cassette, and a CD), units for sound wave correction and audio frequency amplification, speakers, and so on.

Speakers in an audio system for a vehicle are an important component to determine the performance of room acoustics in the vehicle. In order to enjoy stereo music, different kinds of speakers, such as a sub-woofer responsible for a range of a mid-bass band and a tweeter is responsible for providing high audio frequencies, typically from around 2,000 Hz to 20,000 Hz (generally considered to be the upper limit of human hearing).

The tweeter related to the present invention, from among the two kinds of speakers, outputs a range of high frequencies, having a short wavelength and a strong direction characteristic, as described above. Accordingly, the characteristic of sound quality of the audio system is greatly changed according to the output direction.

Conventional tweeters are installed in the inside covers of side mirrors provided in the front doors on both sides of a vehicle, and the output directions thereof are oriented toward the center of a driver's seat and a passenger seat.

In the conventional design however, during night driving, it is difficult to find the tweeters (i.e., the pop-up tweeters) in the is interior of a vehicle because an illumination device is not installed in the pop-up tweeters.

### BRIEF SUMMARY OF THE INVENTION

An embodiment of the present invention relates to a tweeter (e.g., a pop up tweeter) that enables an opening and closing structure according to the use of the tweeter installed in a vehicle and also enables the emission of illumination in the tweeter.

A pop-up tweeter according to the present invention includes a speaker provided at the top of a cylindrical casing; a driving unit inserted into the casing and configured to move the speaker upward and downward; and a cover unit provided at the top end of the speaker and configured to have an illumination unit formed therein.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a diagram showing a pop-up tweeter according to an exemplary embodiment of the present invention; and

FIG. 2 is a diagram showing the state in which the pop-up tweeter of an exemplary embodiment of the present invention is operated.

### DESCRIPTION OF REFERENCE NUMERALS OF PRINCIPAL ELEMENTS IN THE DRAWINGS

100: casing
110: driving unit
111: shaft
120: speaker 121: cover unit
122: illumination unit

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DESCRIPTION OF EMBODIMENT

An exemplary embodiment of the present invention will hereinafter be described in detail with reference to the accompanying drawings.

The embodiment described in the present specification and the configuration shown in the drawings are merely an exemplary embodiment of the present invention and do not represent all of the technical spirit of the present invention. Thus, it should be understood that there may be various equivalents and modified examples that can replace the embodiments described in the present specification and the configuration shown in the drawings at the time of filling the present application.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

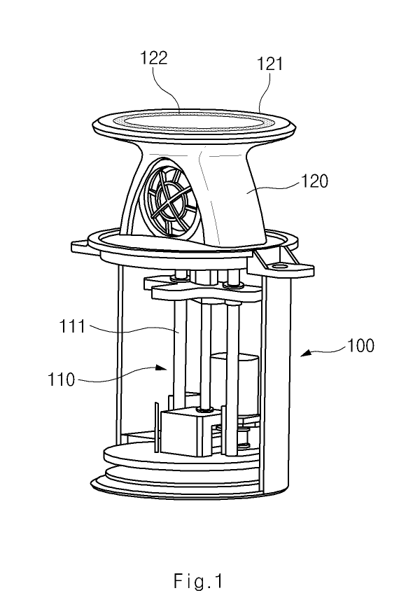

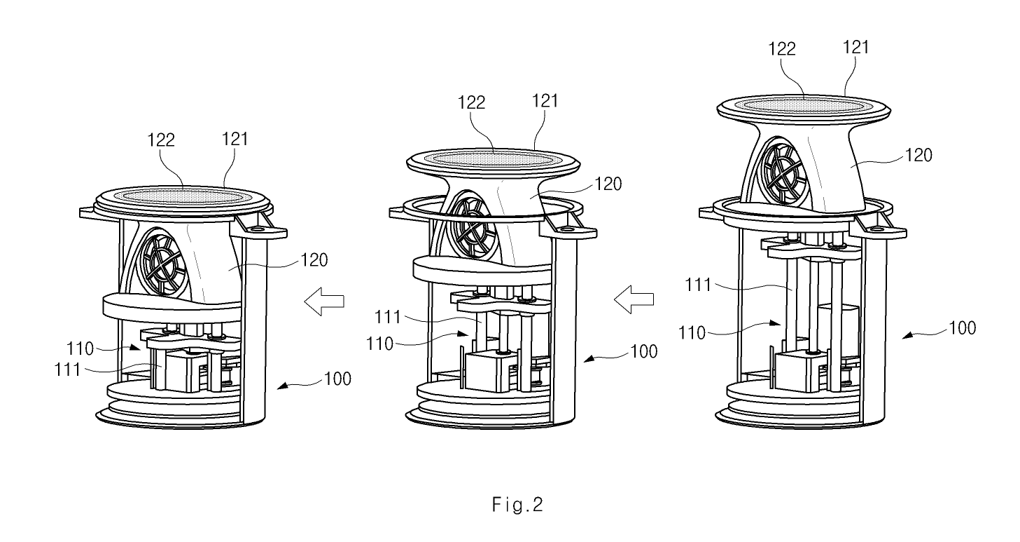

The pop-up tweeter of the present invention, as shown in FIGS. 1 and 2, includes a driving unit 110 disposed within a cylindrical casing 100, a speaker 120 disposed at the top end of the driving unit 110, and a cover unit 121 disposed at the top of the speaker 120 and configured to include an illumination unit 122. In this configuration, when the driving unit 110 is operated, the speaker 120 slides upward or downward, thereby making the illumination unit 122 emit light. Accordingly, user convenience can be improved and design can be maximized.

Hereinafter, each of the elements of the pop-up tweeter according to the present invention is described in detail with reference to the accompanying drawings.

In the present invention, as shown in FIGS. 1 and 2, the speaker 120 is slidably disposed within the casing 100. The casing 100 has a cylindrical shape. The casing 100 is installed within a panel, such as a dashboard, a door, or a tray which is provided in the interior of a vehicle. The speaker 120 is disposed at the top of the casing 100 and is posited toward a passenger. The driving unit 110 is disposed within the casing 100 and is configured to move the speaker 120 upward and downward.

Advantageously, the driving unit 110 can slide upward and downward because shafts 111 are included in the driving unit 110 and are connected to the speaker 120. When a motor (not shown) is rotated, the shafts 111 are rotated, and thus the speaker 120 connected to the shafts 111 moves upward or downward.

The shafts 111 are rotated when the driving unit 110 is driven. When the shafts 111 are rotated clockwise, the speaker 120 protrudes outside the casing 100. When the shafts 111 are rotated counterclockwise, the speaker 120 is inserted into the casing 100.

Additionally, a hollow (not shown) is formed within the speaker 120 so that the shafts 111 can be inserted into the hollow when the driving unit 110 is driven. Accordingly, when a user wants the speaker 120 to be opened, the driving unit 110 is driven to make the speaker 120 protrude outside the casing 100. When a user wants the speaker 120 to be closed, the driving unit 110 is driven to insert the speaker 120 into the casing 100.

The cover unit 121 of a forming shape is formed at the top of the speaker 120. The illumination unit 122 capable of emitting light is formed on the outer side of the cover unit 121.

Here, when the cover unit 121 moves downward in the up and down sliding operations according to the operation of the driving unit 110, the cover unit 121 of the speaker 120 is caught by the top end of the casing 100 so that the speaker 120 is prevented from being fully inserted into the casing 100.

Meanwhile, the cover unit 121 can be molded to have the same material and color as a panel, such as a dashboard, a door, or a tray which is disposed within the vehicle so that the illumination unit 122 of the cover unit 121 emits light on the same line as the skin face of the panel. Accordingly, design within the vehicle can be improved.

Furthermore, a power supply unit (not shown) enabling on/off control is disposed within the vehicle. The power supply unit is operated in conjunction with the driving unit 110 and the illumination unit 122 of the cover unit 121. When power is supplied through the power supply unit, the driving unit 110 is driven and the illumination unit 122 emits light.

When the driving unit 110 is driven and thus the speaker 120 is opened upward, the illumination unit 122 maintains an on state. Even when the speaker 120 is moved downward and closed, the illumination unit 122 can maintain the on state. The illumination of the illumination unit 122 can be turned off illustratively through the off-control of the power supply unit (not shown) operating in conjunction with the illumination unit 122.

Hereinafter, the operation and effects of the present invention are described.

As shown in FIGS. 1 and 2, the driving unit 110 is disposed within the casing 100 of a cylindrical shape. The speaker 120 is mounted on the top end of the driving unit 110. The cover unit 121 having the illumination unit 122 formed therein is disposed at the top end of the speaker 120. When a user wants the speaker 120 to be opened and thus power is supplied, the driving unit 110 slides upward and thus the speaker 120 is operated. At the same time, the power supply unit (not shown) enabling on/off control is operated in conjunction with the driving unit 110 and the illumination unit 122. When power is supplied through the power supply unit, the driving unit 110 is operated and thus the illumination unit 122 emits light.

Consequently, when the speaker 120 is sought to be opened, the driving unit 110 is driven by the power supply unit (not shown) enabling on/off control. When the speaker 120 protrudes outside the casing 100, the speaker 120 is automatically turned on and thus the illumination unit 122 emits light. When the speaker 120 is sought to be closed, the driving unit 110 is driven by the power supply unit and the speaker 120 is inserted into the casing 100, so that the speaker 120 is automatically turned off. At this time, although the speaker 120 is inserted into the casing 100, the illumination unit 122 remains turned on. In order to turn off the illumination of the illumination unit 122, the power supply unit operating in conjunction with the illumination unit 122 should be turned off.

As described above, according to the present invention, the illumination unit is included in a pop-up tweeter. Accordingly, user convenience can be maximized and an external design can be improved through the emission of illumination.

The pop-up tweeter configured as above according to the present invention includes the speaker provided at the top of the casing having a cylindrical shape, the driving unit inserted into the casing and configured to have the speaker upward and downward, and the cover unit provided at the top of the speaker and configured to have the illumination unit formed therein. As described above, the pop-up tweeter is configured to have the opening and closing structure within a vehicle, thereby improving user convenience. Furthermore, an external design of the tweeter can be improved through the emission of illumination. Accordingly, there is an advantage in that merchantability can be increased.

Although a specific embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A tweeter, comprising:
a speaker provided at a top of a cylindrical casing;
a driving unit inserted into the casing and configured to move the speaker upward and downward; and
a cover unit provided at a top end of the speaker and configured to have an illumination unit formed therein to emit light.

2. The tweeter according to claim 1, wherein the casing is inserted into a panel disposed within a vehicle.

3. The tweeter according to claim 1, wherein the cover unit is molded using an identical material with a panel disposed within a vehicle so that the illumination unit emits light on an identical line as a skin face of the panel.

4. The tweeter according to claim 1, wherein the driving unit includes shafts, and the shafts are connected to the speaker.

5. The tweeter according to claim 4, wherein the shafts are rotatably provided when the driving unit is driven, and when the shafts are rotated clockwise, the speaker protrudes outside the casing, and when the shafts are rotated counterclockwise, the speaker is inserted into the casing.

6. The tweeter according to claim 1, wherein:
a power supply unit enabling on/off control is provided in a vehicle and is operated in conjunction with the driving unit and the illumination unit, and
when power is supplied through the power supply unit, the driving unit is driven and the illumination unit emits light.

7. The tweeter according to claim 5, wherein a hollow is formed within the speaker so that the shafts are inserted into the hollow when the driving unit is driven.

8. The tweeter of according to claim 1, wherein the tweeter is a pop-up tweeter.
